(19) United States
(12) Patent Application Publication
(10) Pub. No.: US 2018/0160508 A1
(43) Pub. Date: Jun. 7, 2018

(54) APPARATUS AND METHOD FOR MEASURING AMBIENT LIGHT INTENSITY USING LIGHT-SENSITIVE RESISTOR

(71) Applicant: WIZEDSP LTD., TEL-AVIV (IL)

(72) Inventor: OZ GABAI, TEL-AVIV (IL)

(21) Appl. No.: 15/575,362

(22) PCT Filed: May 19, 2016
(86) PCT No.: PCT/IB2016/052954

§ 371 Date: Nov. 19, 2017

Related U.S. Application Data
(60) Provisional application No. 62/164,474, filed on May 20, 2015.

(51) Int. Cl. H05B 37/02; H05B 33/08

(52) U.S. Cl. CPC H05B 37/0218; H05B 33/0854; H05B 37/0281

(57) ABSTRACT

A method and a system for measuring ambient light, including detecting power transition of electric power powering a LED light source, where the power transition comprises at least one power transition from OFF to ON and at least one power transition from ON to OFF, performing a plurality of measurements of output signal of an LDR measurement circuit, wherein the plurality of measurements is performed between the power transition from ON to OFF and the power transition from OFF to ON, and calculating ambient light intensity from the plurality of measurements where the time period between the power transition from ON to OFF and the power transition from OFF to ON is less than time period for stabilizing LDR light measurement.

### CROSS-REFERENCE TO RELATED APPLICATIONS

This application claims the benefit of U.S. Provisional Application No. 62/164,474, filed May 20, 2015, the disclosures of which is incorporated herein by reference in their entirety.

### FIELD

The method and apparatus disclosed herein are related to the field of measuring light-intensity.

### BACKGROUND

There is a known need to decrease energy consumption, and particularly energy consumed by artificial lighting. During day-time, the amount of artificial light that should be added, for example, in office space, may vary continuously. Modern lighting technologies such as light-emitting diodes (LED) enable efficient and accurate control of the amount of added artificial light. This requires continuous measurement of the natural light intensity in various areas of the work-space also when artificial lighting is operated. There is thus a recognized need for, and it would be highly advantageous to have, a method and a system for measuring ambient light, that overcomes the abovementioned deficiencies.

### SUMMARY

According to one exemplary embodiment, there is provided a method, a device, and a computer program for measuring ambient light including, at least one light-dependent resistor (LDR), an LDR sensor interface circuit electrically coupled to the at least one LDR, a sample-and-hold unit electrically coupled to the LDR sensor interface circuit, an Analog-to-Digital Converter (ADC) electrically coupled to the sample and hold unit, a buffer unit for each LDR, the buffer unit being configured to collect the LDR measurements, a scheduling unit configured to schedule at least two time points for measuring output signal of the LDR to form corresponding LDR measurements, and a processor configured to collect at least one of the LDR measurements and calculate ambient light intensity.

According to another exemplary embodiment the device may additionally include a second scheduler that switches OFF a LED light source, for a small amount of time every few seconds, minutes, hours or days.

According to still another exemplary embodiment the processor is a dedicated hardware.

According to yet another exemplary embodiment the processor is software controlled central processing unit.

Further according to another exemplary embodiment the method for measuring ambient light may include the steps of detecting power transition of electric power powering a LED light source, where the power transition includes at least one power transition from OFF to ON and at least one power transition from ON to OFF, performing a plurality of measurements of output signal of measurement circuit including a light-dependent resistor (LDR), where the plurality of measurements is performed between the power transition from ON to OFF and the power transition from OFF to ON, and calculating ambient light intensity from the plurality of measurements.

Still further according to another exemplary embodiment the time period between the power transition from ON to OFF and the power transition from OFF to ON is less than time period for stabilizing LDR light measurement.

Yet further according to another exemplary embodiment the LDR light measurement stabilizes according to a particular known function which at least one parameter is not known, and the step of calculating ambient light intensity includes calculating the at least one parameter from the plurality of measurements.

Even further according to another exemplary embodiment the time period between the power transition from ON to OFF and the power transition from OFF to ON is associated with pulse width modulation (PWM) of a light source.

Additionally, according to another exemplary embodiment, the light source is proximal to the LDR.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1A is a simplified schematic diagram of a circuit for measuring light intensity;

FIG. 1B is a simplified flow-chart of an algorithm for measuring ambient light using the circuit of FIG. 1A;

FIG. 1C is a simplified flow-chart of an algorithm for measuring light using the circuit of FIG. 1A

FIG. 2A is a simplified time diagram for measuring ambient light for a PWM-controlled LED light source;

FIG. 2B is a simplified time diagram for measuring ambient light for always-on LED light source;

FIG. 3 is a model of an LDR;

FIG. 4 is a simplified schematic diagram of a test circuit for measuring the light intensity using LDR;

FIG. 5 is a simplified time diagram of voltage output of the test circuit of FIG. 4;

FIG. 6A is a simplified time diagram of measurements performed for PWM LED;

FIG. 6B is a simplified time diagram of measurements performed for always-on LED light source;

FIG. 7A is a block diagram of a circuit for ultra-fast measurement of ambient light intensity for PWM controlled LED light source; and

FIG. 7B is a block diagram of a circuit for ultra-fast measurement of ambient light intensity for always on LED light source.

### DETAILED DESCRIPTION

The present embodiments comprise systems and methods for measuring light using a light-sensitive resistor. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The term ‘light-dependent resistor’ or ‘LDR’ may refer to any type of device that is sensitive to light, and particularly any type of resistor, or device having resistance, where the resistance of the device changes according to the light intensity incident on the device. Such devices may also be known as photoresistors or photocells, photoconductors, etc. The LDR resistance usually decreases with increasing incident light intensity.

The purpose of embodiments described below is to provide at least one system and/or method for ultra-fast light intensity measurement of ambient light using LDR.

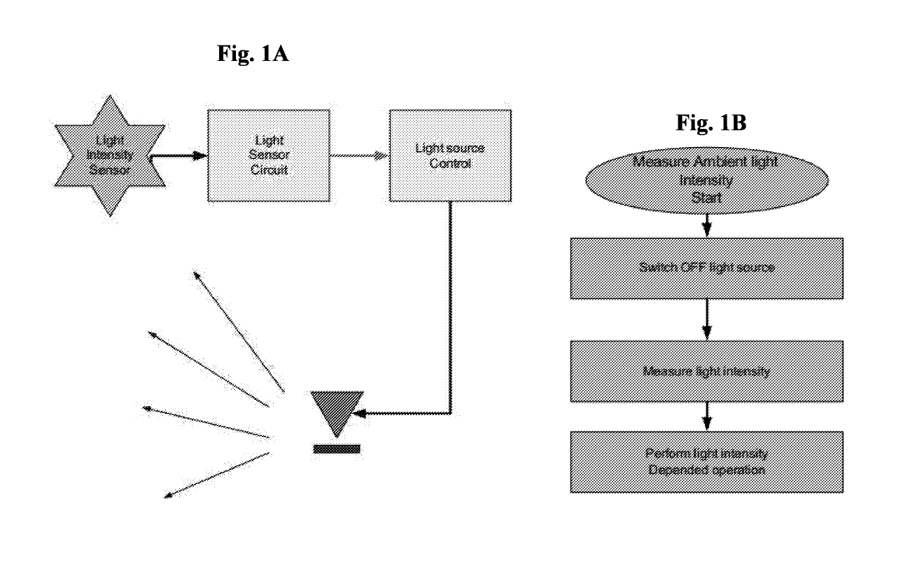

Reference is now made to FIG. 1A, which is a simplified schematic diagram of a circuit for measuring light intensity, to FIG. 1B, which is a simplified flow-chart of an algorithm for measuring ambient light using the circuit of FIG. 1A, and to FIG. 1C, which is a simplified flow-chart of an algorithm for measuring light using the circuit of FIG. 1A, all according to one exemplary embodiment.

In some implementations in order to measure ambient light intensity the sensor is placed in areas which will not be affected by the light source. As shown in FIG. 1B, to measure ambient light intensity, the light source should be turned off. LED-based light sources are turned on and off repeatedly during normal operation to control the light intensity. For example, Pulse Width Modulation (PWM) may be used to control light intensity by turning the LED off for periods shorter than human perception. Therefore, for example, ambient light may be measured during the PWM off periods.

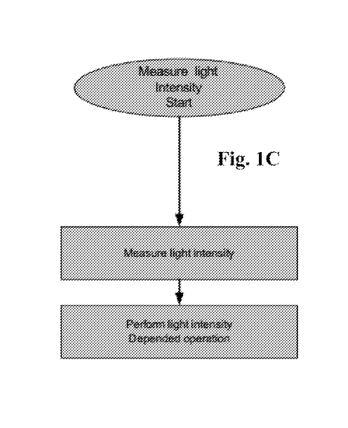

Reference is now made to FIG. 2A, which is a simplified time diagram for measuring ambient light for a PWM-controlled LED light source, and to FIG. 2B, which is a simplified time diagram for measuring ambient light for always-on LED light source, according to two exemplary embodiments.

As an option, the time diagrams of FIGS. 2A and 2B may be viewed in the context of the details of the previous Figures. Of course, however, FIGS. 2A and 2B may be viewed in the context of any desired environment. Further, the aforementioned definitions may equally apply to the description below.

As shown in FIG. 2A, a LED light source is controlled by PWM sequence of pulses and measurements may be performed when the PWM voltage is OFF. As shown in FIG. 2A, a LED light source is always on, and measurements may be performed by turning the LED off for a short time period which may be shorter than human perception. Such measuring periods, e.g., when the operating voltage is off, may be few milliseconds long, and may be repeated every few seconds, to measure ambient light intensity.

Light measurement may be performed using a light depended resistor (LDR).

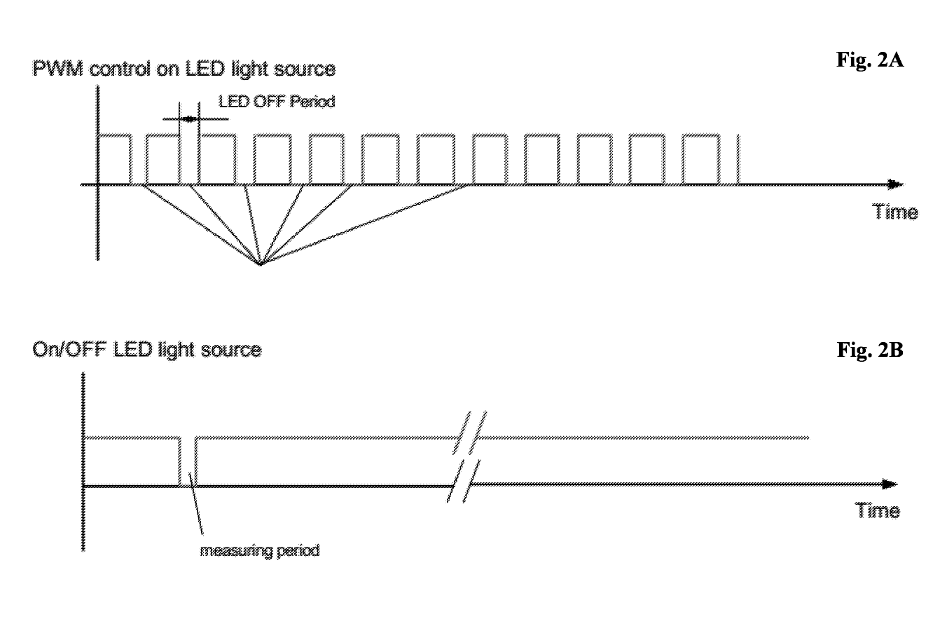

Reference is now made to FIG. 3, which is a model of an LDR, according to one exemplary embodiment.

As an option, the LDR model of FIG. 3 may be viewed in the context of the details of the previous Figures. Of course, however, the LDR model of FIG. 3 may be viewed in the context of any desired environment. Further, the aforementioned definitions may equally apply to the description below.

As shown in FIG. 3, RD is the dark resistance and could be a few Mega Ohm, RV is the variable light depended resistance and is inverse proportional to the light intensity RL is a residual resistance and CP is a few Pico farads.

The problem with using LDR is the long time it takes the LDR to stabilize the resistance after exposing the LDR to light, particularly in low-light conditions. The stabilization time may be 50 msec-100 msec, which is typically longer than the PWM off period, and may be perceived by humans as light flicker.

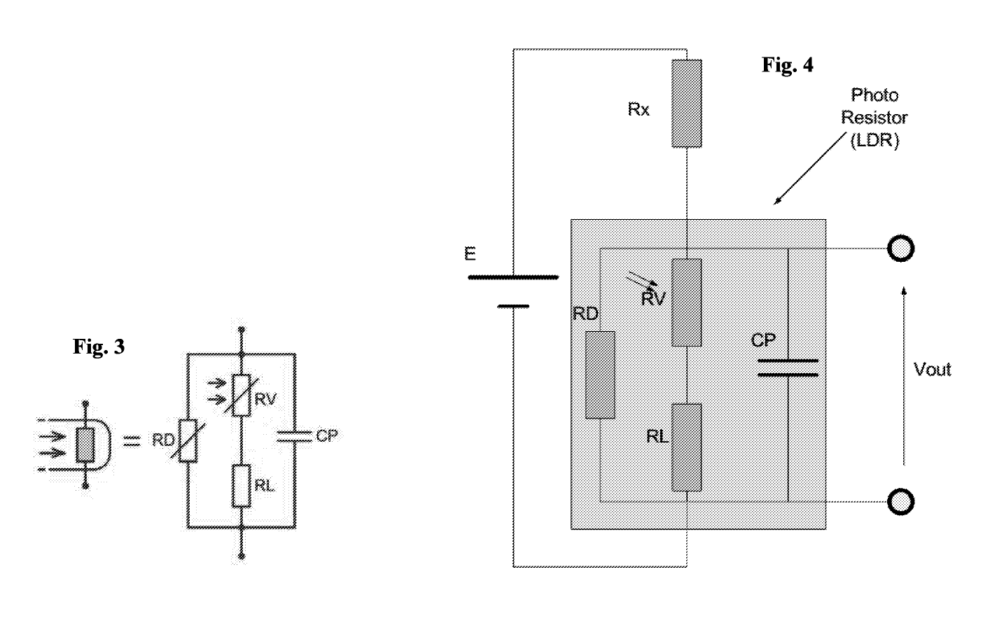

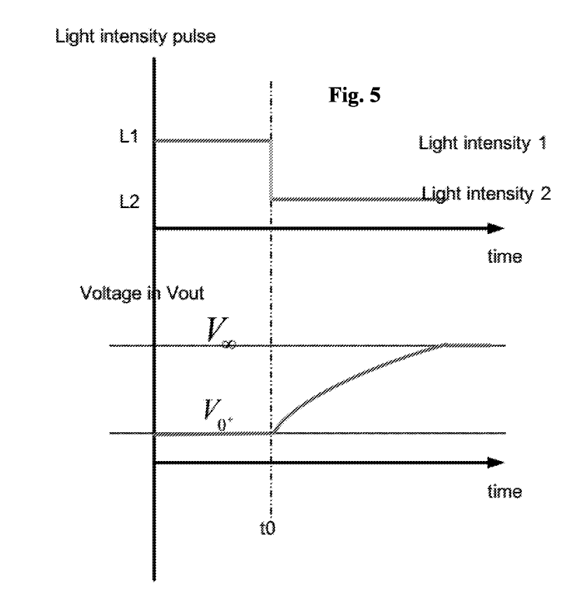

Reference is now made to FIG. 4, which is a simplified schematic diagram of a test circuit for measuring the light intensity using LDR, and to FIG. 5, which is a simplified time diagram of voltage output of the test circuit of FIG. 4, according to one exemplary embodiment.

As an option, the schematic diagram of FIG. 4, and the time diagram of FIG. 5, may be viewed in the context of the details of the previous Figures. Of course, however, the schematic diagram of FIG. 4, and the time diagram of FIG. 5, may be viewed in the context of any desired environment. Further, the aforementioned definitions may equally apply to the description below.

Referring to FIG. 4 one can show that the response to a light step function at as described by FIG. 5 is given by Eq. 1:

$$\begin{matrix}{V}_{out} ( t ) = \{ \begin{matrix}{V}_{{0}^{+}} & t \leq {t}_{0} \\ {V}_{∞} - ( {V}_{∞} - {V}_{{0}^{+}} ) {e}^{\frac{- ( t - {t}_{0} )}{τ}} & t > {t}_{0}\end{matrix} where & Eq . 1 \\ τ = \{ ( {R}_{V} ( {L}_{2} ) + {R}_{L} ) ‖ {R}_{D} ‖ {R}_{X} \} {C}_{P} and & Eq . 2 \\ {V}_{{0}^{+}} = E \frac{( {R}_{V} ( {L}_{1} ) + {R}_{L} ) ‖ {R}_{D}}{( {R}_{V} ( {L}_{1} ) + {R}_{L} ) ‖ {R}_{D} + {R}_{X}} and & Eq . 3 \\ {V}_{∞} = E \frac{( {R}_{V} ( {L}_{2} ) + {R}_{L} ) ‖ {R}_{D}}{( {R}_{V} ( {L}_{2} ) + {R}_{L} ‖ {R}_{D} + {R}_{X}} & Eq . 4\end{matrix}$$

V₀_{⁺} may be measured prior to the switch off operation and then using at least two measures at t1 and t2 one can get

$${V}_{out} ( {t}_{1} ) = {V}_{∞} - ( {V}_{∞} - {V}_{{0}^{+}} ) {e}^{\frac{- ( {t}_{1} - {t}_{0} )}{τ}} \\ {V}_{out} ( {t}_{2} ) = {V}_{∞} - ( {V}_{∞} - {V}_{{0}^{+}} ) {e}^{\frac{- ( {t}_{2} - {t}_{0} )}{τ}} \qquad Eq . 5$$

Eq. 5 represents a set of two equations with two unknowns V_{∞} and τ. Solving Eq. 5 provides the value of V_{∞}, and hence the light intensity when light source is off, which represents the ambient light intensity.

As the time periods when the LED light source is off are controlled and therefore known, then t0 and V₀_{⁺} are also known.

A three-point measurements may be made at t1, t2 and t3, where t1=T+t0, t2=2T+t0, and t3=3T+t0.

$${V}_{out} ( {t}_{1} ) = {V}_{∞} - ( {V}_{∞} - {V}_{{0}^{+}} ) {e}^{\frac{- ( {t}_{1} - {t}_{0} )}{τ}} = {V}_{∞} - ( {V}_{∞} - {V}_{{0}^{+}} ) {e}^{\frac{- T}{τ}} \\ {V}_{out} ( {t}_{2} ) = {V}_{∞} - ( {V}_{∞} - {V}_{{0}^{+}} ) {e}^{\frac{- ( {t}_{2} - {t}_{0} )}{τ}} = {V}_{∞} - ( {V}_{∞} - {V}_{{0}^{+}} ) {e}^{\frac{- 2 T}{τ}} \\ {V}_{out} ( {t}_{3} ) = {V}_{∞} - ( {V}_{∞} - {V}_{{0}^{+}} ) {e}^{\frac{- ( {t}_{2} - {t}_{0} )}{τ}} = {V}_{∞} - ( {V}_{∞} - {V}_{{0}^{+}} ) {e}^{\frac{- 3 T}{τ}} \qquad Eq . 5$$

Then, using Eq. 6,

$$\frac{{V}_{out} ( {t}_{2} ) - {V}_{out} ( {t}_{3} )}{{V}_{out} ( {t}_{1} ) - {V}_{out} ( {t}_{2} )} = \frac{- {e}^{\frac{- 2 T}{τ}} + - {e}^{\frac{- 3 T}{τ}}}{- {e}^{\frac{- T}{τ}} + {e}^{\frac{- 2 T}{τ}}} = \frac{- {x}^{2} + {x}^{3}}{- x + {x}^{2}} = \frac{{x}^{2} ( x - 1 )}{x ( x - 1 )} = x \\ where x = {e}^{\frac{- T}{τ}} , \qquad Eq . 6$$

and then Eq. 7

$$τ = \frac{- T}{ln ( \frac{{V}_{out} ( {t}_{2} ) - {V}_{out} ( {t}_{3} )}{{V}_{out} ( {t}_{1} ) - {V}_{out} ( {t}_{2} )} )} \qquad Eq . 7$$

and one of the equations in Eq. 5, arriving at Eq. 8.

$${V}_{∞} = \frac{{V}_{out} ( {t}_{1} ) - {xV}_{{0}^{+}}}{1 - x} \qquad Eq . 8$$

As x may have some noise, each of the equations of Eq. 5 may be averaged arriving at:

$${V}_{∞} = \frac{1}{3} {\sum }_{k = 1}^{3} \frac{{V}_{out} ( {t}_{k} ) - {x}^{k} {V}_{{0}^{+}}}{1 - {x}^{k}} \qquad Eq . 9$$

In some cases we would have some noises in the measurements such that the x calculation of Eq. 6 may give x+ noise. Therefore, instead of making three measurements we will make more measurements such as N measurements.

$$\begin{matrix}{V}_{out} ( {t}_{1} ) = {V}_{∞} - ( {V}_{∞} - {V}_{{0}^{+}} ) {e}^{\frac{- ( {t}_{1} - {t}_{0} )}{τ}} = {V}_{∞} - ( {V}_{∞} - {V}_{{0}^{+}} ) {e}^{\frac{- T}{τ}} \\ {V}_{out} ( {t}_{2} ) = {V}_{∞} - ( {V}_{∞} - {V}_{{0}^{+}} ) {e}^{\frac{- ( {t}_{2} - {t}_{0} )}{τ}} = {V}_{∞} - ( {V}_{∞} - {V}_{{0}^{+}} ) {e}^{\frac{- 2 T}{τ}} \\ {V}_{out} ( {t}_{3} ) = {V}_{∞} - ( {V}_{∞} - {V}_{{0}^{+}} ) {e}^{\frac{- ( {t}_{2} - {t}_{0} )}{τ}} = {V}_{∞} - ( {V}_{∞} - {V}_{{0}^{+}} ) {e}^{\frac{- 3 T}{τ}} \\ {V}_{out} ( {t}_{4} ) = {V}_{∞} - ( {V}_{∞} - {V}_{{0}^{+}} ) {e}^{\frac{- ( {t}_{4} - {t}_{0} )}{τ}} = {V}_{∞} - ( {V}_{∞} - {V}_{{0}^{+}} ) {e}^{\frac{- 4 T}{τ}} \\ ⋮ \\ ⋮ {V}_{out} ( {t}_{1} ) = {V}_{∞} - ( {V}_{∞} - {V}_{{0}^{+}} ) {e}^{\frac{- ( {t}_{N} - {t}_{0} )}{τ}} = {V}_{∞} - ( {V}_{∞} - {V}_{{0}^{+}} ) {e}^{\frac{- NT}{τ}}\end{matrix} \qquad Eq . 10$$

one possibility is to define

$$\begin{matrix}{y}_{1} = x + {n}_{1} = \\ {y}_{2} = x + {n}_{2} = \frac{{V}_{out} ( {t}_{3} ) - {V}_{out} ( {t}_{4} )}{{V}_{out} ( {t}_{2} ) - {V}_{out} ( {t}_{3} )} \\ ⋮ \\ {y}_{N - 2} = x + {n}_{N - 2} = \frac{{V}_{out} ( {t}_{N - 1} ) - {V}_{out} ( {t}_{N} )}{{V}_{out} ( {t}_{N - 2} ) - {V}_{out} ( {t}_{N - 1} )}\end{matrix} \qquad Eq . 11$$

and then

$$x = \frac{1}{N - 2} {\sum }_{k = 1}^{N - 2} \frac{{V}_{out} ( {t}_{k + 1} ) - {V}_{out} ( {t}_{k + 2} )}{{V}_{out} ( {t}_{k} ) - {V}_{out} ( {t}_{k + 1} )} \qquad Eq . 12$$

Alternatively,

$$τ = \frac{1}{N - 2} {\sum }_{k = 1}^{N - 2} \frac{- T}{ln ( \frac{{V}_{out} ( {t}_{k + 1} ) - {V}_{out} ( {t}_{k + 2} )}{{V}_{out} ( {t}_{k} ) - {V}_{out} ( {t}_{k + 1} )} )} \qquad Eq . 13$$

using Eq. 14

$$x = {e}^{\frac{- T}{τ}} \qquad Eq . 14$$

Therefore, the use of Eqs. 13 and 14 may arrive at the same result for x as with Eq. 12.

Therefore, similar to Eq. 9. one can deduce

$${V}_{∞} = \frac{1}{N} {\sum }_{k = 1}^{N} \frac{{V}_{out} ( {t}_{k} ) - {x}^{k} {V}_{{0}^{+}}}{1 - {x}^{k}} \qquad Eq . 15$$

Another option may be to make measurements on known time indexes but on time differences other than T and then to solve least square problem to estimate the ambient light intensity.

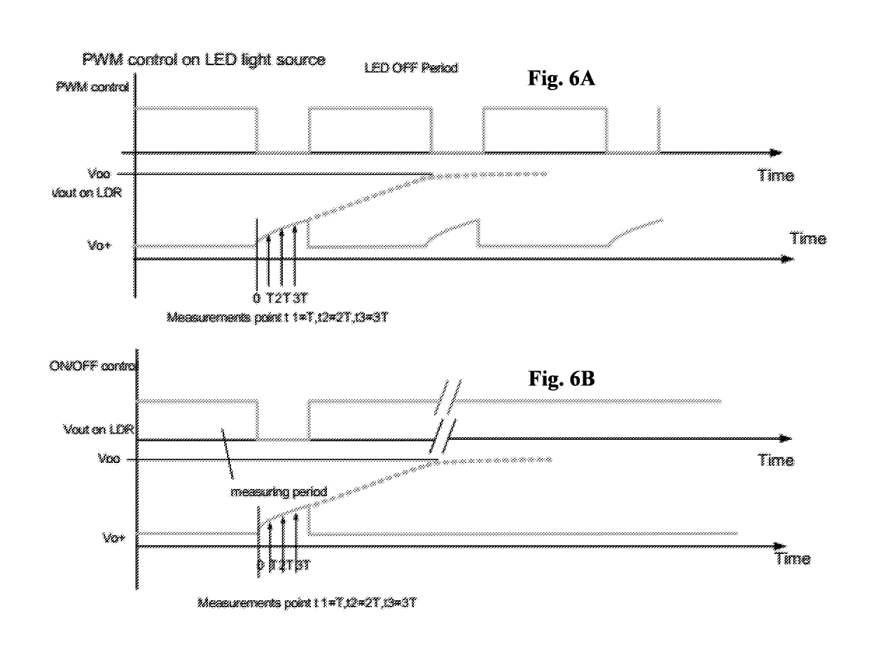

Reference is now made to FIG. 6A, which is a simplified time diagram of measurements performed for PWM LED, and to FIG. 6B, which is a simplified time diagram of measurements performed for always-on LED light source, according to two exemplary embodiments.

As an option, the time diagrams of FIGS. 6A and 6B may be viewed in the context of the details of the previous Figures. Of course, however, the time diagrams of FIGS. 6A and 6B may be viewed in the context of any desired environment. Further, the aforementioned definitions may equally apply to the description below.

Eq. 15 and Eq. 9 show how the measures done in FIGS. 6A and 6B could be used to estimate and therefore the ambient light intensity.

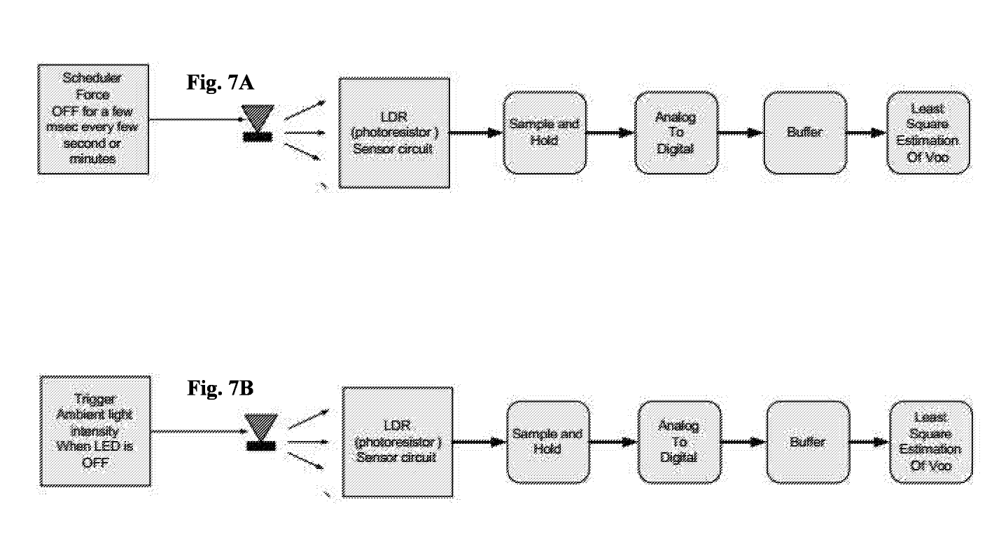

Reference is now made to FIG. 7A, which is a block diagram of a circuit for ultra-fast measurement of ambient light intensity for PWM controlled LED light source, and to FIG. 7B, which is a block diagram of a circuit for ultra-fast measurement of ambient light intensity for always on LED light source, according to two exemplary embodiments.

As an option, the block diagrams of FIGS. 7A and 7B may be viewed in the context of the details of the previous Figures. Of course, however, the block diagrams of FIGS. 7A and 7B may be viewed in the context of any desired environment. Further, the aforementioned definitions may equally apply to the description below.

It is appreciated that ambient light intensity using either of the circuits of FIGS. 7A and 7B may include many LDR's for measuring the ambient light in different zones.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

What is claimed is:

1. A device for measuring ambient light comprising:
at least one light-dependent resistor (LDR);
an LDR sensor interface circuit electrically coupled to the at least one LDR;
a sample-and-hold unit electrically coupled to the LDR sensor interface circuit;
an Analog-to-Digital Converter (ADC) electrically coupled to the sample and hold unit;
a buffer unit for each LDR, the buffer unit being configured to collect the LDR measurements;
a scheduling unit configured to schedule at least two time points for measuring output signal of the LDR to form corresponding LDR measurements; and
a processor configured to collect at least one of the LDR measurements and calculate ambient light intensity.

2. The device according to claim 1, additionally comprising
a second scheduler that switches OFF a LED light source, for a short time every few seconds, minutes, hours or days.

3. The device according to claim 1, wherein the processor is a dedicated hardware.

4. The device according to claim 1, wherein the processor is software controlled central processing unit.

5. A method for measuring ambient light, the method comprising:
detecting power transition of electric power powering a LED light source, wherein said power transition comprises at least one power transition from OFF to ON and at least one power transition from ON to OFF;
performing a plurality of measurements of output signal of measurement circuit comprising a light-dependent resistor (LDR), wherein said plurality of measurements is performed between said power transition from ON to OFF and said power transition from OFF to ON; and
calculating ambient light intensity from said plurality of measurements.

6. The method of claim 5, wherein said time period between said power transition from ON to OFF and said power transition from OFF to ON is less than time period for stabilizing LDR light measurement.

7. The method of claim 6, wherein a function of said stabilizing LDR light measurement is known except for at least one parameter and wherein said calculating ambient light intensity comprises calculating said at least one parameter from said plurality of measurements.

8. The method of claim 5, wherein said time period between said power transition from ON to OFF and said power transition from OFF to ON is associated with pulse width modulation (PWM) of a light source.

9. The method of claim 8, wherein said light source is proximal to said LDR.
